(19) United States
(12) Patent Application Publication
(10) Pub. No.: US 2004/0023716 A1
(43) Pub. Date: Feb. 5, 2004

(54) Jackpot gaming system having jackpot display

(75) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(73) Assignee: Atronic International GmbH

(21) Appl. No.: 10/458,002

(22) Filed: Jun. 9, 2003

(30) Foreign Application Priority Data
Jun. 26, 2002 (DE) 102 28 457.1

(51) Int. Cl. G07F 17/34

(52) U.S. Cl. 463/26

(57) ABSTRACT

In one embodiment, on an additional display unit for each gaming machine in a system of gaming machines, a jackpot game is played after each main game on an associated gaming machine. A jackpot control unit, common to all gaming machines, predetermines the jackpot game outcome for each gaming machine. A jackpot win is determined by the jackpot control unit based on a triggering event. The main game and jackpot game may be the spinning of actual or virtual reels, where the resulting symbol combinations determine the award to the player. Because the display for the jackpot symbols may be situated in a separate housing, it can be connected to any gaming machine without modifying the machine.

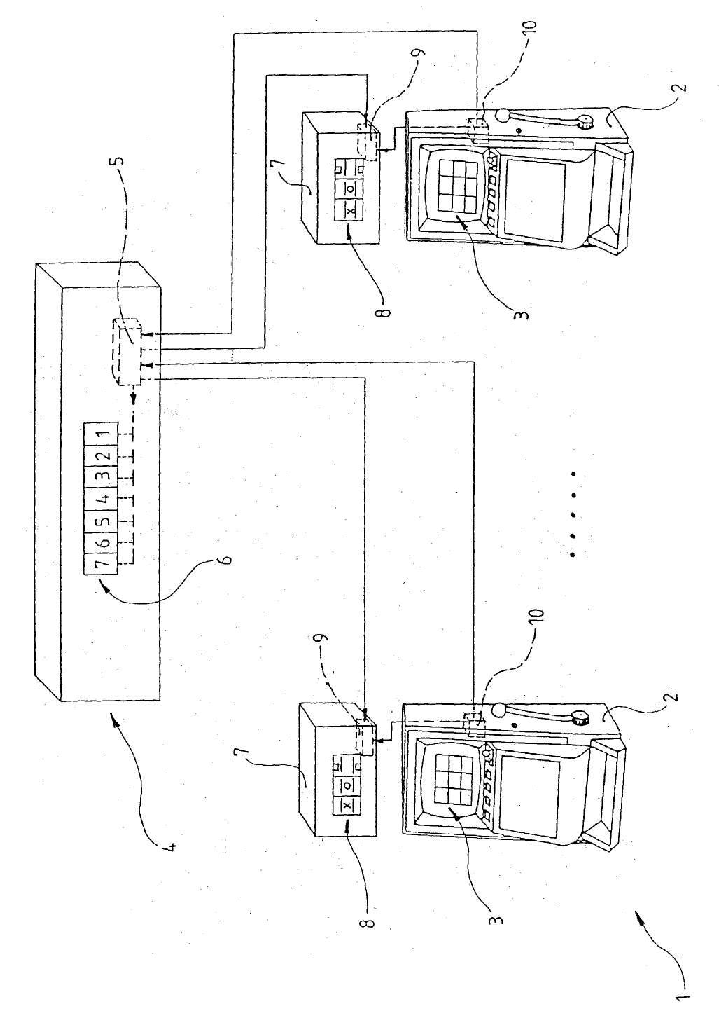

### FIELD OF THE INVENTION

This invention relates to jackpot gaming systems and, in particular, to a technique for awarding a jackpot.

### BACKGROUND

From the German Application DE 198 42 832.A1, a jackpot gaming system is known, comprising a jackpot control unit located in a separate housing having a display to display a jackpot amount. Coin operated gaming machines are connected to the control unit. The jackpot is filled with a certain percentage of every single bet of the gaming machines connected to the jackpot gaming system. The jackpot gaming system includes at least two jackpot counters. The first jackpot counter is displayed. The filling of the jackpots can occur equally or non-equally. At some triggering time, the jackpot control unit instructs a gaming machine to display a jackpot symbol combination as an outcome of the main game played by the gaming machine. The displayed jackpot amount is awarded to the player, and a selected portion of the second jackpot counter fills the starting jackpot amount up to an attractive level. If the jackpot is triggered very infrequently, some players may experience a low interest to play the gaming machine for a long period of time.

### SUMMARY

It is the purpose of the present invention to increase the player's satisfaction and to increase the tension of the game. After a main game is played on the gaming machine, a jackpot game is displayed on an additional display unit for each gaming machine. The jackpot game may display symbol combinations that award the full jackpot or a lower jackpot value, symbol combinations that award a fixed bonus value, or symbol combinations that grant no award. The symbol combination obtained in the additional display for each machine is determined randomly or based on any other triggering event, such as a predetermined time or a certain level of the jackpot being attained. Accordingly, after each game or at certain intervals, the player experiences the excitement of a possible jackpot win. The jackpot game may use other than symbol combinations.

Because the display for the jackpot symbols may be situated in a separate housing, it can be connected to any gaming machine without modifying the machine. Existing gaming machines do not have to be replaced by new ones, as the additional display means can be attached to existing gaming machines. Gaming machines equipped with this additional display device are much more attractive to the player, since an extra opportunity to win is provided.

In one embodiment, the main control unit for the jackpot system informs the control unit of the additional display at the end of every single game whether to display a jackpot-triggering symbol combination, a near miss jackpot combination, a winning symbol combination for a lower prize, or a no win combination.

An advantage of the jackpot system described above is that it may operate independently of the original gaming system, so the jackpot system is simple to add to an existing system. The jackpot system is self-funded from the wagers.

In another embodiment, the additional display described above is integral to a gaming machine (i.e., within the machine's housing).

### BRIEF DESCRIPTION OF THE DRAWING

The FIGURE illustrates a gaming system augmented with a jackpot system in accordance with one embodiment of the invention.

### DETAILED DESCRIPTION

One embodiment of the present invention is illustrated in the FIGURE.

A gaming system 1 comprises several gaming machines 2, each with a symbol-displaying device 3. The displaying device 3 may be a display screen (e.g., CRT, LCD, etc.), motor-driven reels, flip-card units, a flexible tape with symbols, or other suitable device. The gaming machines 2 are connected to a common jackpot device 4.

The jackpot device 4 comprises a jackpot control unit 5, including a microcomputer. The microcomputer controls a numerical display 6, which may display the current jackpot amount. The jackpot control unit may instead be the microcomputer inside one of the gaming machines, acting as a master, where the functions of the gaming machine and jackpot control unit are performed by the same microcomputer.

Each gaming machine 2 is connected to an associated display device 7, which can be located in a separate housing or within the machine 2 housing. The display device 7, which can be positioned on top of every gaming machine 2, comprises a display 8 to display the symbol combinations in the jackpot game. The display 8 may be a display screen (e.g., CRT, LCD, etc.), motor-driven reels, flip-card units, a flexible tape with symbols, or other suitable device.

In another embodiment, the same display 3 used in the main game is controlled by the jackpot control unit 5 to display a symbol combination for winning the jackpot.

A display control unit 9, incorporating a microcomputer, controls the display 8. The display control unit 9 may control, for example, the spinning of reels in display 8 and may include conventional communication circuitry for communicating between the jackpot control unit 5 and the main control unit 10 of the gaming machine 2.

After a symbol combination is displayed on the symbol-displaying device 3 of the gaming machine 2, a signal, which indicates the end of a game on the gaming machine 2, is sent from the control unit 10 to the display control unit 9. The jackpot control unit 5 is also connected to the display control unit 9. The jackpot control unit 5 signals to the display control unit 9 if a symbol combination to trigger the jackpot will be displayed on display 8, if a symbol combination will be displayed that misses only one symbol to trigger the jackpot (near miss situation), or other symbol combination. A symbol combination displayed by display 8 may also award non-jackpot awards.

In another embodiment, the jackpot control unit 5 does not activate display 8 after each game but only upon certain triggering events, such as certain symbol combinations being obtained in the main game.

To operate the gaming machine 2, a coin of a predetermined minimum denomination value is inserted. In other embodiments, the machine accepts bills, paper tickets, encoded cards, or any other monetary equivalent.

A predetermined and adjustable part of the bet is used to fill the jackpot of the jackpot device 4, which can be a progressive or other type of jackpot. The control unit 10 of the gaming machine 2 transmits a signal to increment the jackpot after receipt of the minimum bet. An amount encoded in the signal increases the displayed amount on the jackpot counter of the jackpot control unit 5. The jackpot counter may be a function of the microcomputer in the control unit 5. The jackpot amount is displayed on a numerical display 6 with several digits.

The control unit 10 of the gaming machine 2 controls the display of a winning or non-winning symbol combination on display 3. At the end of a game, the control unit 10 of the gaming machine 2 transmits a signal to the display control unit 9 that the game is finished. The display control unit 9 also receives signals from the jackpot control unit 5 dictating the final outcome on display 8. The control unit 9 then displays the predetermined outcome.

In one embodiment, control unit 5 informs control unit 9 whether or not a jackpot combination is to be displayed, and control unit 9 displays the jackpot combination. For all other symbol combinations, control unit 9 may act independently to display non-jackpot combinations.

The display control unit 9 displays the predetermined symbol combination on the display 8. The synchronization of the game between the gaming machine 2 and the display device 7 ensures that, after playing a main game, the player can experience further excitement. This can be achieved by displaying a symbol combination which may trigger the jackpot. The outcome of the display 8 may be determined by a pseudo random number generator within the jackpot device 4 or by economic parameters which can be set by the operator.

The exact time of the trigger event of the jackpot may be determined exclusively by the jackpot control unit 5. The trigger event may be a randomly selected time, or when the jackpot reaches a randomly selected level, or based on any other factor. Upon the triggering event occurring, one of the display control units 9 will be instructed by the jackpot control unit 5 to display a winning symbol combination, which triggers the jackpot. The gaming machine then either pays the jackpot to the player or signals for an attendant to pay the player.

Once the jackpot has been won, the jackpot counter will be reset to a predetermined starting value or another jackpot counter, which is operated in the background and not initially visible to the player, will be displayed.

The invention may be implemented using conventional hardware. Programming of the various microcomputers is well within the skills of programmers in the gaming field. While particular embodiments of the present invention have been shown and described, it will be obvious to those skill in the art that changes and modifications may be made without departing from this invention in its broader aspects and, therefore, the appended claims are to encompass within their scope all changes and modifications that fall within the true spirit and scope of the invention.

What is claimed is:

1. A method performed by a gaming device comprising:
playing a main game on a gaming machine and displaying an outcome on the gaming machine;
accumulating a jackpot amount;
playing and displaying a jackpot game after the main game, wherein the jackpot game is played irrespective of an outcome of the main game; and
awarding a player the jackpot amount for a jackpot-winning outcome of the jackpot game.

2. The method of claim 1 wherein playing and displaying the jackpot game comprises playing and displaying the jackpot game after each main game.

3. The method of claim 1 wherein playing a main game on a gaming machine and displaying an outcome on the gaming machine comprises displaying the main game on a first display in a housing of the gaming machine, and wherein playing and displaying the jackpot game comprises displaying the jackpot game on a display external to the housing of the gaming machine.

4. The method of claim 1 wherein playing and displaying a jackpot game comprises predetermining an outcome of the jackpot game by a jackpot control unit separate from the gaming machine.

5. The method of claim 1 wherein playing a main game on a gaming machine and displaying an outcome on the gaming machine comprises displaying reels to obtain one or more symbols combinations.

6. The method of claim 5 wherein displaying reels comprises displaying reels on a display screen.

7. The method of claim 1 wherein playing and displaying a jackpot game comprises displaying reels to obtain one or more symbols combinations.

8. The method of claim 7 wherein displaying reels comprises displaying reels on a display screen.

9. The method of claim 1 wherein playing and displaying a jackpot game after the main game comprises:
receiving a signal that the main game has been played; and
in response to such signal, displaying the jackpot game.

10. The method of claim 1 wherein accumulating a jackpot amount comprises allocating a percentage of wagers for playing the main game to a jackpot.

11. The method of claim 1 wherein playing and displaying a jackpot game comprises determining an outcome of the jackpot game by a jackpot control unit separate from the gaming machine, wherein the jackpot control unit determines a jackpot outcome based on a triggering event.

12. The method of claim 11 wherein the triggering event is a random time event.

13. The method of claim 11 wherein the triggering event is a jackpot level.

14. The method of claim 1 wherein the gaming machine is one of a plurality of gaming machines connected to a common jackpot control unit, and wherein playing and displaying a jackpot game comprises determining, by the jackpot control unit, which gaming machine will win the jackpot based on a triggering event unrelated to an outcome of the main game.

15. The method of claim 14 further comprising displaying a jackpot amount on a display common to the plurality of gaming machines, and wherein playing and displaying a jackpot game comprises displaying an outcome of the jackpot game on a display associated with a particular gaming machine.

16. The method of claim 15 wherein the jackpot control unit predetermines whether the outcome of the jackpot game will be a jackpot outcome, a non-jackpot win outcome, or a non-winning outcome.

17. A jackpot system comprising:
a jackpot control unit, common to a plurality of gaming machines, for predetermining a jackpot outcome of a jackpot game played by the plurality of gaming machines;
a first jackpot display for displaying a jackpot amount common to the plurality of gaming machines; and
a second jackpot display, associated with a particular gaming machine, for displaying the outcome of the jackpot game, determined by the jackpot control unit, after play of a main game by the particular gaming machine.

18. The system of claim 17 further comprising the plurality of gaming machines playing main games, each gaming machine having an associated second jackpot display separate from a main game display for the gaming machine.

19. The system of claim 17 further comprising a jackpot counter for accumulating the jackpot amount based on a percentage of wagers to play the main game.

20. The system of claim 17 wherein the main game comprises displaying spinning reels to obtain one or more symbol combinations.

21. The system of claim 17 wherein the jackpot game comprises displaying spinning reels to obtain one or more symbol combinations.

22. The system of claim 17 wherein the second jackpot display comprises a display screen.

23. The system of claim 17 wherein the jackpot control unit determines whether an outcome of the jackpot game is a jackpot-winning outcome or a non-jackpot-winning outcome.

24. The system of claim 17 wherein the jackpot control unit determines a jackpot-winning outcome of the jackpot game based on a triggering event.

25. The system of claim 24 wherein the triggering event is a random time event.

26. The system of claim 24 wherein the triggering event is a jackpot level.

27. The system of claim 24 wherein the triggering event is irrespective of results from the main game.

28. The system of claim 17 wherein the jackpot control unit determines an outcome of a jackpot game for each play of the main game.

29. The system of claim 17 further comprising a display control unit for each second display, the display control unit receiving a signal for each play of a main game and displaying a jackpot game outcome determined by the jackpot control unit.
